(19) United States
(12) Patent Application Publication
(10) Pub. No.: US 2005/0138123 A1
(43) Pub. Date: Jun. 23, 2005

(54) Apparatus and method for offering event image mail service using multimedia messaging service

(76) Inventors: Hong-Seo Yun, Daejeon (KR); Sang-Hee Lee, Seoul (KR); Sang-Mok Sohn, Gyeonggi-do (KR); Woo-Jung Yang, Jeju-do (KR); Hyun-Jung Park, Seoul (KR)

Correspondence Address: LAHIVE & COCKFIELD, LLP., 28 STATE STREET, BOSTON, MA, 02109, US

(21) Appl. No.: 10/497,463

(22) PCT Filed: Oct. 23, 2002
(86) PCT No.: PCT/KR02/01980

(30) Foreign Application Priority Data
Dec. 14, 2001 (KR) 2001/0079300

(51) Int. Cl. G06F 15/16

(52) U.S. Cl. 709/206; 709/207; 709/246

(57) ABSTRACT

The present invention discloses an apparatus and method for offering an event image mail service using a multimedia messaging service and a computer-readable recording medium which records a program for performing the method. The apparatus for offering the event image mail service includes: an encoding means for editing multimedia data from an input means, generating an event image mail, and uploading the event image mail to a relay server; the relay server for transmitting the event image mail uploaded by the encoding means to a storing means and a transcoding means, and transmitting the transcoded event image mail from the transcoding means to a push proxy gateway center; the storing means for storing the event image mail from the relay server; the transcoding means for transcoding the event image mail from the relay server to be suitable for a subscriber terminal environment, and transmitting the transcoded event image mail to the relay server; and the push proxy gateway center for receiving a user agent profile from a subscriber terminal and transmitting it to the relay server, and receiving the event image mail transcoded by the transcoding means from the relay server and providing it to the subscriber terminal.

### TECHNICAL FIELD

The present invention relates to an apparatus and method for offering an event image mail service using a multimedia messaging service and a computer-readable recording medium which records a program for performing the method, and in particular to an apparatus and method for offering an event image mail service using a multimedia messaging service which can provide highlights of an event such as a sports game in a real time in form of an image mail on a multimedia messaging service infrastructure, and a computer-readable recording medium which records a program for performing the method.

### BACKGROUND ART

In general, a short message service (SMS) enables cellular phone subscribers to transmit/receive a short message. When one digital cellular phone subscriber transmits a Korean or English short sentence to another cellular phone subscriber, the cellular phone subscriber can receive the message through a public switched telephone network, data communication network or internet.

Recently, the SMS has offered scores to the subscribers who cannot go to a sports game or other events but want to receive movement, result or highlight information thereof. However, the SMS can transmit maximally 78 bytes of characters, to reduce quantity and quality of services.

### DISCLOSURE OF INVENTION

Accordingly, it is a primary object of the present invention to provide an apparatus for offering an event image mail service using a multimedia messaging service which can provide event information to subscribers through a multimedia by using a push proxy gateway center/SMS center and a relay server.

Another object of the present invention is to provide a method for offering an event image mail service using a multimedia messaging service which can provide event information to subscribers through a multimedia by using a push proxy gateway center/SMS center and a relay server.

Yet another object of the present invention is to provide a computer-readable recording medium which records a program for performing a function of providing event information to subscribers through a multimedia by using a push proxy gateway center/SMS center and a relay server.

In order to achieve the above-described objects of the invention, there is provided an apparatus for offering an event image mail service using a multimedia messaging service which includes an input means and a subscriber terminal for transmitting an event image mail in form of an instant message, including: an encoding means for editing multimedia data from the input means, generating the event image mail, and uploading the event image mail to a relay server; the relay server for transmitting the event image mail uploaded by the encoding means to a storing means and a transcoding means, and transmitting the transcoded event image mail from the transcoding means to a push proxy gateway center; the storing means for storing the event image mail from the relay server; the transcoding means for transcoding the event image mail from the relay server to be suitable for a subscriber terminal environment, and transmitting the transcoded event image mail to the relay server; and the push proxy gateway center for receiving a user agent profile from the subscriber terminal and transmitting it to the relay server, and receiving the event image mail transcoded by the transcoding means from the relay server and providing it to the subscriber terminal.

In another aspect of the invention, an apparatus for offering an event image mail service using a multimedia messaging service which includes an input means and a subscriber terminal for transmitting an event image mail with the confirmation of a subscriber, includes: an encoding means for editing multimedia data from the input means, generating the event image mail, and uploading the event image mail to a relay server; the relay server for receiving the event image mail uploaded by the encoding means, guiding the event image mail to a short message service center, transmitting the event image mail to a storing means and a transcoding means, and transmitting the transcoded event image mail from the transcoding means to the subscriber terminal; the storing means for storing the event image mail from the relay server; the transcoding means for transcoding the event image mail from the relay server to be suitable for a subscriber terminal environment, and transmitting the transcoded event image mail to the relay server; and the short message service center for notifying reception of the event image mail to the subscriber terminal.

In yet another aspect of the invention, a method for offering an event. image mail service using a multimedia messaging service which provides an event image mail in form of an instant message, includes: a first step for editing and uploading the event image mail; a second step for storing the event image mail, and searching a terminal number by referring to a terminal database; a third step for confirming whether a subscriber terminal can receive the event image mail, and confirming a subscriber terminal environment when it can receive the event image mail; a fourth step for transcoding the event image mail to be suitable for the subscriber terminal environment; and a fifth step for transmitting the event image mail transcoded in the fourth step to the subscriber terminal.

In yet another aspect of the invention, a method for offering an event image mail service using a multimedia messaging service which provides an event image mail with confirmation of a subscriber, includes: a first step for editing and uploading the event image mail; a second step for storing the event image mail, and searching a terminal number by referring to a terminal database; a third step for confirming whether a subscriber terminal can receive the event image mail, and notifying reception of the event image mail when it can receive the event image mail; a fourth step for confirming a reception request of the event image mail by the subscriber terminal; a fifth step for transcoding the event image mail to be suitable for a subscriber terminal environment; and a sixth step for transmitting the event image mail transcoded in the fifth step to the subscriber terminal.

### BRIEF DESCRIPTION OF THE DRAWINGS

The present invention will become better understood with reference to the accompanying drawings which are given only by way of illustration and thus are not limitative of the present invention, wherein:

FIG. 1 is a structure view illustrating an apparatus for offering an event image mail service using a multimedia messaging service in accordance with a first embodiment of the present invention;

FIG. 2 is a flowchart showing a method for offering the event image mail service using the multimedia messaging service in accordance with the first embodiment of the present invention;

FIG. 3 is a structure view illustrating an apparatus for offering an event image mail service using a multimedia messaging service in accordance with a second embodiment of the present invention; and

FIG. 4 is a flowchart showing a method for offering the event image mail service using the multimedia messaging service in accordance with the second embodiment of the present invention.

### BEST MODE FOR CARRYING OUT THE INVENTION

An apparatus and method for offering an event image mail service using a multimedia messaging service (MMS) in accordance with preferred embodiments of the present invention will now be described in detail with reference to the accompanying drawings.

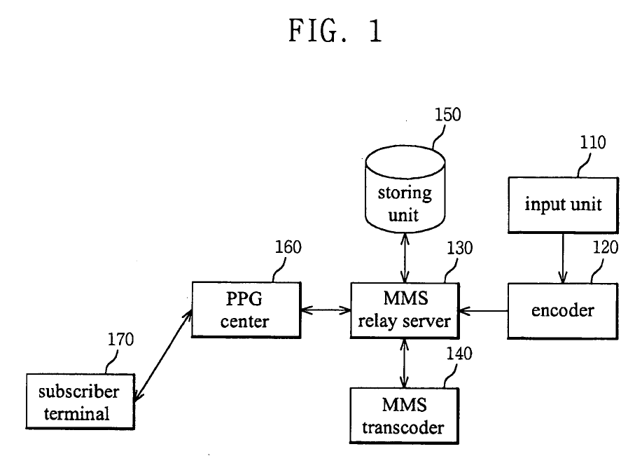

FIG. 1 is a structure view illustrating an apparatus for offering an event image mail service using the MMS in accordance with a first embodiment of the present invention. Here, an event image mail is transmitted in form of an instant message.

Referring to FIG. 1, the apparatus for offering the event image mail service includes: an input unit 110, an encoder 120, an MMS relay server 130, an MMS transcoder 140, a storing unit 150, a push proxy gateway (PPG) center 160 and a subscriber terminal 170.

Exemplary input units 110 include apparatuses for photographing motion pictures such as a motion picture camera and a camcorder, and serve to monitor a real sports game or event.

The encoder 120 edits scoring scenes or highlights of major games by using multimedia data transmitted from the input unit 110, generates an event image mail by editing scores or commentaries in form of audio or text, and uploads the event image mail to the MMS relay server 130. Here, the event image mail can be uploaded by employing a hypertext transfer protocol (HTTP).

The MMS relay server 130 stores the data uploaded by the encoder 120 in the storing unit 150, and transmits them to the MMS transcoder 140. In addition, the MMS relay server 130 searches a database of a terminal which will receive the event image mail, confirms whether the subscriber terminal can receive the event image mail, and transmits the multimedia message transcoded by the MMS transcoder 140 to the PPG center 160 when it can receive the event image mail.

The MMS transcoder 140 transcodes the image mail according to a corresponding subscriber terminal environment. For example, the MMS transcoder 140 can transcode a CODEC algorithm between the media. That is, the MMS transcoder 140 can transcode a mutual still image CODEC algorithm such as BMP and SIS, and JPEG and SIS in still images, AVI into MPEG4 and H.263 into MPEG4 in motion pictures, EVRC into WAV and QCELP into AAC-3 or G.723.1 in sounds, flash into MLZ and other 3Ds into mobile flash in animations, and MIDI into MP3 and Wav into MP3 in audio images.

In the case of images, the MMS transcoder 140 can also change a color depth and resolution. That is, it is possible to reduce large-sized images (QCIF, etc.) to small-sized images (SQCIF, etc), lower a high color depth (24 bit color, etc) to a low color depth (8 bit color or 4 gray, etc.), or modify an image whose width is greater than length to an image whose length is greater than width by scaling and cutting to control a ratio of width to length.

The MMS transcoder 140 can mutually transcode media, namely transcodes one scene of MPEG4 or animation motion pictures into JPEG to get still images, or encodes a few still images into animation. In addition, the MMS transcoder 140 synthesizes text by an audio or sound CODEC algorithm so that subscribers can hear it, and is linked to an UMS server (not shown) for transcoding FAX into still images or H.26L motion pictures into animation such as a-GIF or MLZ.

The MMS transcoder 140 can translate foreign languages.

The PPG center 160 receives a user agent (UA) profile from the subscriber terminal 170 upon the request of the MMS relay server 130, transmits the UA profile to the MMS relay server 130, receives the event image mail from the MMS relay server 130, and transmits the event image mail to the subscriber terminal 170.

The UA profile can be a parameter including an environment of the subscriber terminal 170.

The subscriber terminal 170 is a still image/motion picture decoder or gray or color LCD mounted mobile terminal. Exemplary subscriber terminals include a cellular phone, PCS phone, PDA, IMT-2000 phone and next generation mobile communication terminal.

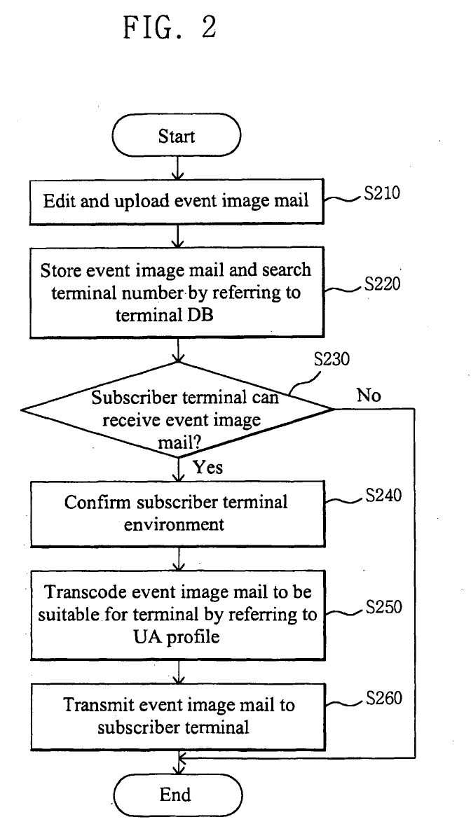

FIG. 2 is a flowchart showing a method for offering the event image mail service using the MMS in accordance with the first embodiment of the present invention. Here, the event image mail is transmitted in form of an instant message.

As shown in FIG. 2, the encoder 120 edits the event image mail by using the multimedia data monitored by the input unit 110, and uploads the event image mail by using the HTTP (S210).

The MMS relay server 130 stores the uploaded event image mail in the storing unit 150, and the storing unit 150 searches a terminal number by referring to the terminal DB (S220), and confirms whether the subscriber terminal can receive the event image mail (S230).

When the subscriber terminal can receive the event image mail, the MMS relay server 130 receives the UA profile from the PPG center 160, and confirms the environment of the subscriber terminal 170 (S240). Here, the PPG center 160 receives the UA profile from the subscriber terminal 170 and transmits it to the MMS relay server 130.

The MMS transcoder 140 transcodes the edited event image mail to be suitable for the terminal environment (S250).

The MMS relay server 130 transmits the event image mail transcoded by the MMS transcoder 140 to the PPG center 160, and the PPG center 160 transmits the event image mail to the subscriber terminal (S260).

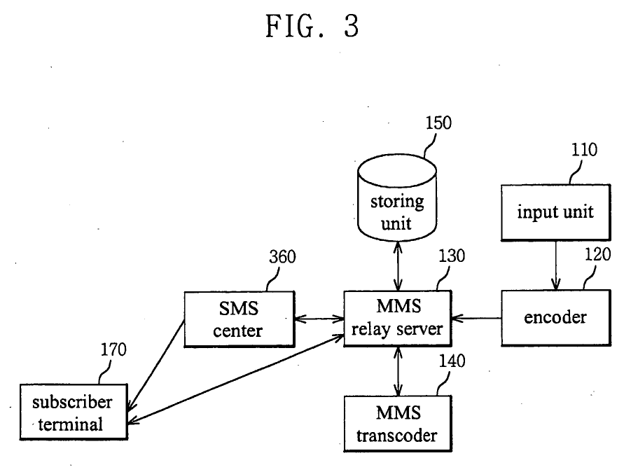

FIG. 3 is a structure view illustrating an apparatus for offering an event image mail service using the MMS in accordance with a second embodiment of the present invention.

Here, an event image mail is transmitted with intermediate confirmation of a subscriber.

As illustrated in FIG. 3, the apparatus for offering the event image mail service includes: an input unit 110, an encoder 120, an MMS relay server 130, an MMS transcoder 140, a storing unit 150, a short message service (SMS) center 360 and a subscriber terminal 170.

The apparatus of FIG. 3 has the same constitutional elements as the apparatus of FIG. 1 except for the SMS center 360, and thus differences which have not been explained in the first embodiment will now be explained.

When receiving the edited event image mail from the encoder 120, the MMS relay server 130 guides the event image mail to the SMS center 360. In addition, when the subscriber requests reception of the event image mail, the MMS relay server 130 transmits the event image mail to the subscriber terminal 170. Here, the event image mail can be downloaded to the subscriber terminal 170 by using a wireless application protocol (WAP).

The SMS center 360 notifies reception of the event image mail to the subscriber terminal 170 through the SMS.

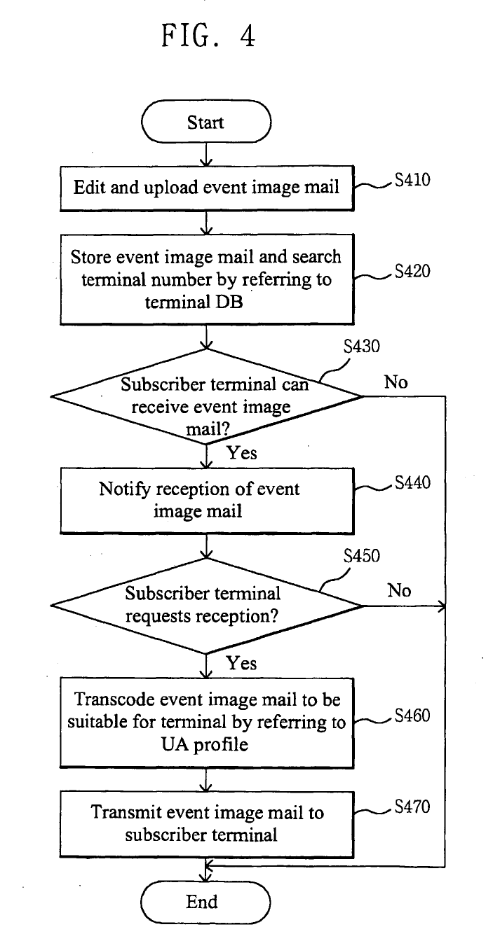

FIG. 4 is a flowchart showing a method for offering the event image mail service using the MMS in accordance with the second embodiment of the present invention. Here, the event image mail is transmitted with intermediate confirmation of the subscriber.

As depicted in FIG. 4, the encoder 120 edits the event image mail by using the multimedia data monitored by the input unit 110, and uploads the event image mail by using the HTTP (S410).

The MMS relay server 130 stores the uploaded event image mail in the storing unit 150, and the storing unit 150 searches a terminal number by referring to the terminal DB (S420), and confirms whether the subscriber terminal can receive the event image mail (S430).

When the subscriber terminal can receive the event image mail, the SMS center 360 transmits an SMS message for notifying reception of the event image mail to the subscriber terminal (S440).

When the subscriber terminal 170 requests reception of the image mail (S450), the MMS relay server 130 confirms an environment of the subscriber terminal 170 by referring to the UA profile transmitted with the request for the image mail reception, and the MMS transcoder 140 transcodes the edited event image mail to be suitable for the terminal environment (S460).

The MMS relay server 130 transmits the event image mail transcoded by the MMS transcoder 140 to the subscriber terminal (S470).

As discussed earlier, in accordance with the present invention, highlights (for example, scoring scenes) of the sports game or event are transmitted in a real time to the service subscribers with still images, motion pictures, audio and text. Accordingly, the subscribers can be provided with wanted sports game or event information through the multimedia. In this case, the subscribers can directly receive the multimedia information through instant messaging, or receive it with intermediate confirmation using SMS notification.

In addition, the method of the invention can be stored in a computer-readable recording medium (CD ROM, RAM, ROM, floppy disk, hard disk, optical magnetic disk, etc.) which records the program.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalences of such metes and bounds are therefore intended to be embraced by the appended claims.

In accordance with the present invention, highlights of the event are transmitted in a real time with the motion pictures, still images, audio and text, so that the subscribers can receive the multimedia event information through the portable terminals.

Moreover, it is possible to confirm whether the subscribers intend to receive the image mail through the SMS. Therefore, the subscribers can reject unwanted mails.

1. An apparatus for offering an event image mail service using a multimedia messaging service which includes an input means and a subscriber terminal for transmitting an event image mail in form of an instant message, comprising:
an encoding means for editing multimedia data from the input means, generating the event image mail, and uploading the event image mail to a relay server;
the relay server for transmitting the event image mail uploaded by the encoding means to a storing means and a transcoding means, and transmitting the transcoded event image mail from the transcoding means to a push proxy gateway center;
the storing means for storing the event image mail from the relay server;
the transcoding means for transcoding the event image mail from the relay server to be suitable for a subscriber terminal environment, and transmitting the transcoded event image mail to the relay server; and
the push proxy gateway center for receiving a user agent profile from the subscriber terminal and transmitting it to the relay server, and receiving the event image mail transcoded by the transcoding means from the relay server and providing it to the subscriber terminal.

2. The apparatus according to claim 1, wherein the encoding means uploads the event image mail by using a hypertext transfer protocol.

3. An apparatus for offering an event image mail service using a multimedia messaging service which includes an input means and a subscriber terminal for providing an event image mail with the confirmation of a subscriber, comprising:
an encoding means for editing multimedia data from the input means, generating the event image mail, and uploading the event image mail to a relay server;
the relay server for receiving the event image mail uploaded by the encoding means, guiding the event image mail to a short message service center, transmitting the event image mail to a storing means and a transcoding means, and transmitting the transcoded event image mail from the transcoding means to the subscriber terminal;
the storing means for storing the event image mail from the relay server;
the transcoding means for transcoding the event image mail from the relay server to be suitable for a subscriber terminal environment, and transmitting the transcoded event image mail to the relay server; and
the short message service center for notifying reception of the event image mail to the subscriber terminal.

4. The apparatus according to claim 3, wherein the relay means transmits the transcoded event image mail to the subscriber terminal by using a wireless application protocol.

5. The apparatus according to claim 1, wherein the transcoding means transcodes a CODEC algorithm between the media.

6. The apparatus according to claim 1, wherein the transcoding means transcodes a color depth of images.

7. The apparatus according to claim 1, wherein the transcoding means transcodes resolution of images.

8. The apparatus according to claim 1, wherein the transcoding means mutually transcodes the media.

9. The apparatus according to claim 1, wherein the transcoding means translates foreign languages.

10. A method for offering an event image mail service using a multimedia messaging service which provides an event image mail in form of an instant message, comprising:
a first step for editing and uploading the event image mail;
a second step for storing the event image mail, and searching a terminal number by referring to a terminal database;
a third step for confirming whether a subscriber terminal can receive the event image mail, and confirming a subscriber terminal environment when it can receive the event image mail;
a fourth step for transcoding the event image mail to be suitable for the subscriber terminal environment; and
a fifth step for transmitting the event image mail transcoded in the fourth step to the subscriber terminal.

11. The method according to claim 10, wherein the third step comprises:
a sixth step for confirming whether the subscriber terminal can receive the event image mail;
a seventh step for requesting a user agent profile of the subscriber terminal; and
an eighth step for receiving the user agent profile from the subscriber terminal, and confirming an environment of the subscriber terminal.

12. The method according to claim 10, wherein the fifth step comprises:
a sixth step for transmitting the transcoded event image mail from a relay server to a push proxy gateway center; and
a seventh step for transmitting the transcoded event image mail from the push proxy gateway center to the subscriber terminal.

13. A method for offering an event image mail service using a multimedia messaging service which provides an event image mail with confirmation of a subscriber, comprising:
a first step for editing and uploading the event image mail;
a second step for storing the event image mail, and searching a terminal number by referring to a terminal database;
a third step for confirming whether a subscriber terminal can receive the event image mail, and notifying reception of the event image mail when it can receive the event image mail;
a fourth step for confirming a reception request of the event image mail by the subscriber terminal;
a fifth step for transcoding the event image mail to be suitable for a subscriber terminal environment; and
a sixth step for transmitting the event image mail transcoded in the fifth step to the subscriber terminal.

14. The method according to claim 13, wherein reception of the event image mail is notified by using the short message service.

15. The method according to claim 13, wherein the reception request of the subscriber terminal comprises a user agent profile of the subscriber terminal.
